(19) United States
(12) Patent Application Publication
(10) Pub. No.: US 2009/0070756 A1
(43) Pub. Date: Mar. 12, 2009

(54) SYSTEM AND METHOD FOR RESOURCE UTILIZATION-BASED THROTTLING OF SOFTWARE UPDATES

(76) Inventors: Hongfeng WEI, Cerritos, CA (US); William Su, Riverside, CA (US); Jianxin Wang, Trabuco Canyon, CA (US); Ajit Sodhi, Irvine, CA (US); Manjunathan Padua, Lake Forest, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/851,121

(22) Filed: Sep. 6, 2007

(51) Int. Cl. G06F 9/44

(52) U.S. Cl. 717/172

(57) ABSTRACT

The subject application is directed to a system and method for resource utilization-based throttling of software updates. A transfer of updated software is first commenced to a document processing device so as to perform an update of operational software associated with the device. Resource utilization associated with the operation of the document processing device is then sensed. In accordance with an output of the sensed resource utilization, an update process is throttled associated with the document processing device and the updated software.

### BACKGROUND OF THE INVENTION

The subject application is directed generally to updating device software. The application is particularly suited for completing software updates to document processing devices in a way that minimizes competition with other resources associated with device operation.

Document processing devices conventionally include printers, copiers, facsimile machines, and scanners. Document processing devices having more than one function are becoming pervasive, and are referred to as multifunction peripherals or MFPs.

Modern document processing devices employ onboard computer systems, referred to as controllers, to manage device operation. As with conventional computer systems, controllers employ both hardware and software to accomplish their functionality. Hardware includes one or more processors, memory, and software. Memory typically includes both volatile and non-volatile storage. Software typically includes an underlying operating environment, one or more application level programs, device drivers, and interface elements. Software typically evolves with updates to existing code or loading of additional code to support additional features or functions.

Software modification for controllers are suitably accomplished by an administrator who transports new or modified software to a device, such as via flash drive, CD, DVD, or other transportable storage. The administrator will enter a privileged access mode to the device, and undertake a load and installation of the desired software. While effective, such manual installation procedures are time consuming, and not desirable for large installations, such as offices which may have tens or hundreds of document processing devices that must be maintained.

More recently, software loading has been accomplished via a network. New or modified code is either pushed down from an administrative machine or pulled from a known source by operation of appropriate software on a document processing device. Since software installation can compete for controller resources with other tasks or may disable certain device functions during installation, it is often advantageous to complete an upgrade during a period of device inactivity.

Many current update schemes will choose to have software installed at ostensibly quiet periods, such as 3:00 a.m. While this is somewhat effective, many factors may prevent fixed update times from being optimal. For example, in a global economy, incoming facsimile messages may come in throughout the night from different time zones. Impaired functionality of such a facsimile device may result in missed communications. As another example, many companies will defer large document processing jobs to off hours so as not to tie up essential office machinery. Such deferred document processing operations may conflict with scheduled update periods, causing slowed or interrupted operation such that a job is not completed satisfactorily.

### SUMMARY OF THE INVENTION

In accordance with one embodiment of the subject application, there is provided a system and method for updating device software.

Further, in accordance with one embodiment of the subject application, there is provided a system and method for completing software updates to document processing devices in a way that minimizes competition with other resources associated with device operation.

Still further, in accordance with one embodiment of the subject application, there is provided a system and method for resource utilization-based throttling of software updates. The system comprises software transfer means adapted for commencing a transfer of updated software to a document processing device so as to perform an update of operational software associated therewith. The system also comprises sensing means adapted for sensing resource utilization associated with operation of the document processing device and control means adapted for throttling an update process associated with the document processing device and the updated software in accordance with an output of the sensing means.

In one embodiment of the subject application, resource utilization includes at least one utilization parameter from the set comprising bandwidth utilization associated with a data path with the document processing device, processor utilization of a processor associated with the document processing device, and memory utilization associated with the document processing device.

In another embodiment of the subject application, the control means includes means adapted for periodically altering the update process in accordance with temporally displaced output from the sensing means. In a further embodiment, the control means further includes means adapted for throttling the update process in accordance with a mathematical function related to an output of the sensing means. In yet another embodiment, the control means includes means adapted for suspending the update process in accordance with an output of the sensing means.

In one embodiment of the subject application, the update process includes at least one process chosen from the set comprising communicating the operational software to the document processing device and installing the operational software on the document processing device.

In yet another embodiment of the subject application, the operational software includes executable code adapted to be executed by a processor associated with the document processing device during processing of electronic documents communicated thereto. In another embodiment, the operational software includes non-executable code corresponding to operational parameters associated with the document processing device. In a further embodiment, the operational software includes an associated installation utility adapted for updating the operational software.

In yet another embodiment, the system further comprises means adapted for enabling the software transfer means at a selected time.

Still further, in accordance with one embodiment of the subject application, there is provided a method for resource utilization-based throttling of software updates in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for resource utilization-based throttling of software updates according to one embodiment of the subject application;

FIG. 2 is a block diagram illustrating controller hardware for use in the system for resource utilization-based throttling of software updates according to one embodiment of the subject application;

FIG. 3 is a functional diagram illustrating the controller for use in the system for resource utilization-based throttling of software updates according to one embodiment of the subject application;

FIG. 4 is a diagram illustrating a server for use in the system for resource utilization-based throttling of software updates according to one embodiment of the subject application;

FIG. 5 is a flowchart illustrating a method for resource utilization-based throttling of software updates according to one embodiment of the subject application; and

FIG. 6 is a flowchart illustrating a method for resource utilization-based throttling of software updates according to one embodiment of the subject application.

### DETAILED DESCRIPTION OF THE PREFERRED EMBODIMENT

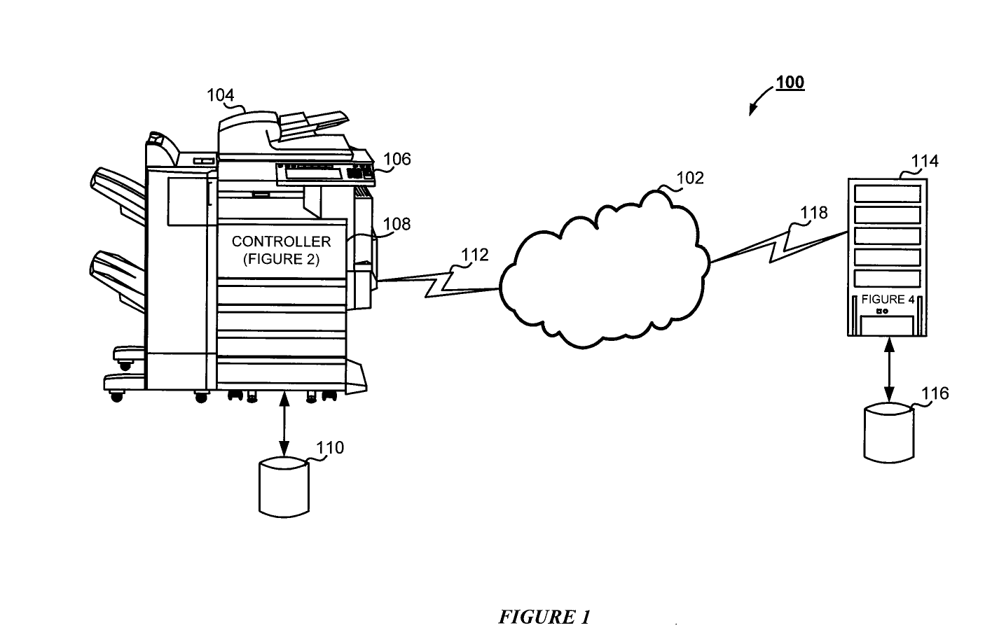

The subject application is directed to a system and method for updating device software. In particular, the subject application is directed to a system and method for completing software updates to document processing devices in a way that minimizes competition with other resources associated with device operation. It will become apparent to those skilled in the art that the system and method described herein are suitably adapted to a plurality of varying electronic fields employing software updates, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for resource utilization-based throttling of software updates in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

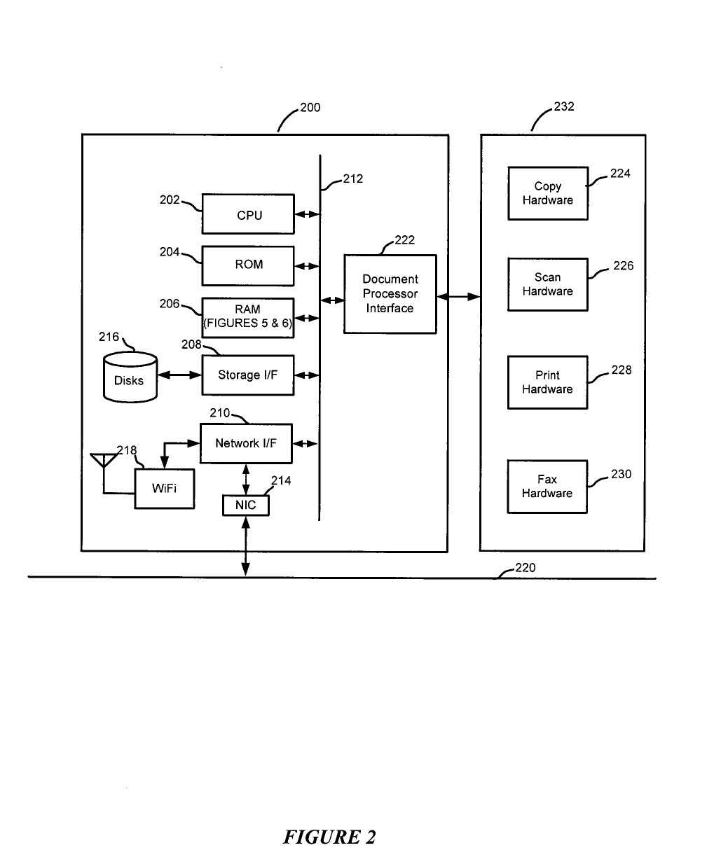

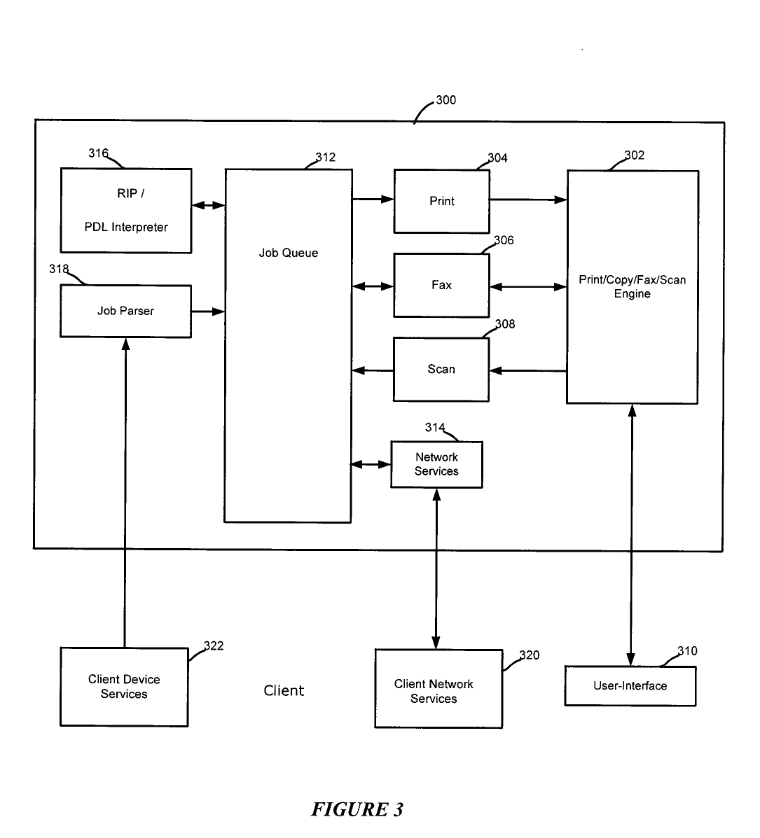

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for resource utilization-based throttling of software updates of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like.

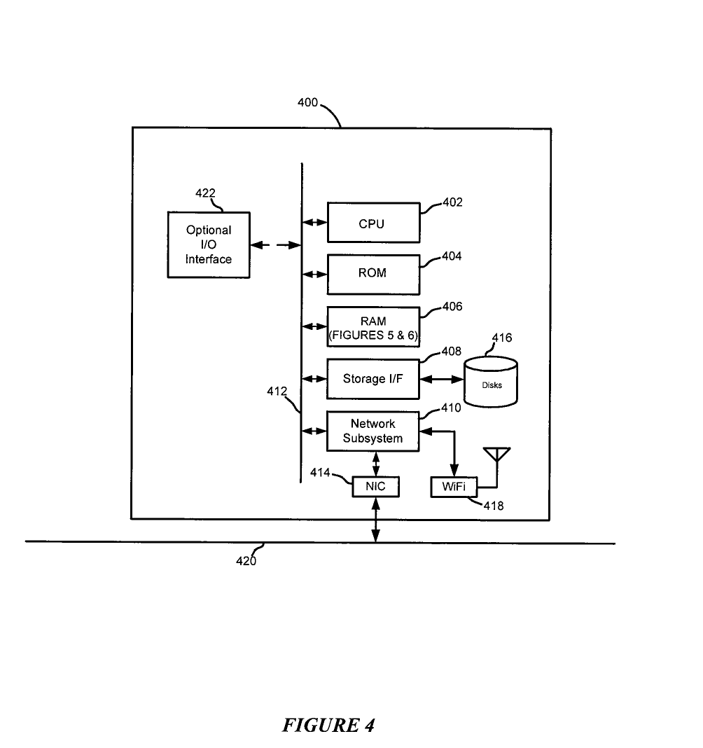

The system 100 of FIG. 1 also includes a network server 114, communicatively coupled to the computer network 102 via a communications link 118. It will be appreciated by those skilled in the art that the server 114 comprises hardware, software, and combinations thereof suitably adapted to provide one or more services, web-base applications, storage options, and the like, to networked devices. In accordance with one embodiment of the subject application, the server 114 includes various components, implemented as hardware, software, or a combination thereof, for managing the performance of web services processes accessed via the computer network 102. The communications link 118 is any suitable data communications means known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. It will be appreciated by those skilled in the art that the components for updating document processing device 104 software described with respect to the server 114 hereinafter are capable of implementation on any computing device coupled to the computer network 102 and functioning as a server side of a client/server relationship. The functioning of the server 114 will better be understood in conjunction with the block diagrams illustrated in FIG. 4, explained in greater detail below.

Communicatively coupled to the server 114 is a data storage device 116. In accordance with the preferred embodiment of the subject application, the data storage device 116 is any mass storage device known in the art including, for example and without limitation, magnetic storage drives, a hard disk drive, optical storage devices, flash memory devices, or any suitable combination thereof. In the preferred embodiment, the data storage device 116 is suitably adapted to store software updates, update lists, electronic database data, document data, image data, or the like. It will be appreciated by those skilled in the art that while illustrated in FIG. 1 as being a separate component of the system 100, the data storage device 116 is capable of being implemented as internal storage component of the network server 114, or the like, such as, for example and without limitation, an internal hard disk drive, or the like

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data s communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by bus 212.

Also in data communication with bus the 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controller 108) as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FITP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

Turning now to FIG. 4, illustrated is a representative architecture of a suitable server 400, depicted in FIG. 1 as the server 114, on which operations of the subject system are completed. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404, which is advantageously used for static or fixed data or instructions, such as BIOS functions, system functions, system configuration, and other routines or data used for operation of the server 400.

Also included in the server 400 is random access memory 406, suitably formed of dynamic random access memory, static random access memory, or any other suitable, addressable memory system. Random access memory provides a storage area for data instructions associated with applications and data handling accomplished by the processor 402.

A storage interface 408 suitably provides a mechanism for volatile, bulk or long term storage of data associated with the server 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the server 400 to communicate to other devices. The network interface subsystem 410 suitably interfaces with one or more connections with external devices to the server 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network subsystem 210 is suitably accomplished via a bus data transfer mechanism, such as illustrated by bus 412.

Suitable executable instructions on the server 400 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 422 as will be appreciated by one of ordinary skill in the art.

In operation, a transfer of updated software is commenced to a document processing device so as to perform an update of operational software associated with the device. Resource utilization associated with the operation of the document processing device is then sensed. In accordance with an output of the sensed resource utilization, an update process is throttled associated with the document processing device and the updated software.

In accordance with one example embodiment of the subject application, software updates are received by a server 114 and stored in the data storage device 116. Preferably, these software updates correspond to software configured to operate on a document processing device 104, such as configuration updates, feature updates or additions, network settings, user administration settings, or other types of software facilitating or controlling operations of the associated document processing device 104. The skilled artisan will appreciate that such software updates are capable of being received by the server 114 from an administrative user, from another server (not shown) on the computer network 102, as a communication from an administrative device (not shown), or the like. The server 114 thereafter publishes an update list of software updates associated with operational software of the document processing device 104. Upon receipt of a request from an associated document processing device 104, the update list is communicated to the requesting document processing device 104 via the computer network 102. In accordance with one embodiment of the subject application, the communication between the document processing device 104 and the server 114 is capable of occurring through multiple firewalls, multiple networks, an intranet, or the like.

The controller 108 or other suitable component associated with the document processing device 104 receives the update list and processes the list so as to determine what updates to operational software are available for implementation by the document processing device 104. Upon a determination by the controller 108 or other suitable component of the document processing device 104 that no software updates are available, the operation terminates with the document processing device 104 continuing to perform document processing operations in accordance with its existing software.

When the controller 108 determines that one or more updates are available, a determination is made whether or not such updates are time restricted. That is, whether or not a software update is restricted to off-operation hours, e.g., early AM, late PM, following a predetermined period of inactivity, or the like. The skilled artisan will appreciate that such time restricted updates typically correspond to operational software updates requiring the receiving document processing device 104 to cease performing document processing operations, shut down, restart, or the like. In the event that such updates are time restricted, the controller 108 waits until the appropriate time has arrived prior to beginning or throttling the update process.

Once the appropriate time has arrived, or when the software update is not restricted to a particular time, resource utilization associated with the document processing device 104 is sensed. That is, the controller 108 or other component associated with the document processing device 104 is tasked with determining bandwidth utilization associated with a data path with the document processing device, processor utilization of a processor associated with the document processing device, memory utilization associated with the document processing device, or the like. The skilled artisan will appreciate that each of the example resources above is representative of an element that affects the transfer and/or installation of the updated software with respect to the document processing device 104. When resources are not available, e.g., high network traffic, intense document processing jobs, or the like, the operation terminates with the updates not applied until such time as resources are available for updating the operational software of the document processing device 104.

When resources are determined to be available, any incomplete transfers, e.g., software updates that were interrupted by network congestion, document processing operations, or the like, are retrieved from the data storage device 110 and the transfer and implementation of such software is then undertaken by the document processing device 104. The skilled artisan will appreciate that when a transfer of software updates is interrupted, e.g., resources are not available, the document processing device 104 via the controller 108 suspends the update process, and stores suspension data representing wherein the update process the interruption occurred and the software update already received, if the interruption occurred during transmission of the software from the server 114 to the document processing device 104.

When resources are available and no incomplete transfers or updates remain to be processed, the transfer of the software update from the server 114 to the document processing device 104 is then commenced. Thereafter, the controller 108 or other suitable component associated with the document processing device 104 monitors the update process for completion of the transfer. In the event that the transfer is interrupted, e.g., resources become unavailable, the transfer is suspended and suspension data is recorded on the data storage device 110 so as to enable the completion of the update process at a later time, e.g., when resources are available. Once a transfer has been completed, the controller 108 or other suitable component associated with the document processing device 104 determines whether any other software updates are pending. When additional updates are available, the controller 108 or other suitable component associated with the document processing device 104 returns to the update list and begins the process of retrieving and implementing the next software update in accordance with the methodology set forth above. When no additional software updates are determined, the transferred updates are implemented by the document processing device 104 and the operation terminates.

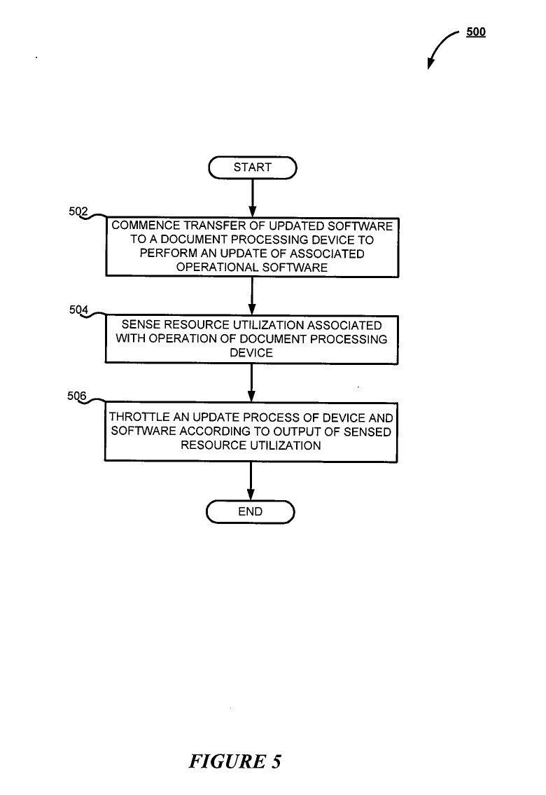

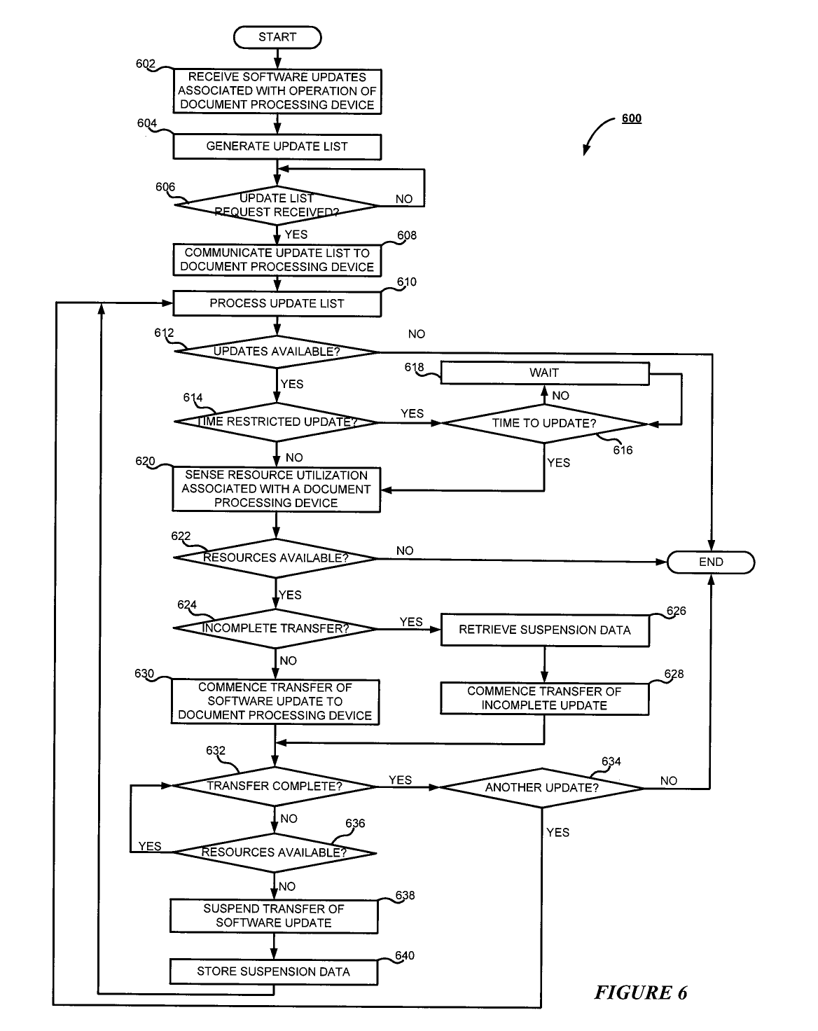

The skilled artisan will appreciate that the subject system 100 and components described above with respect to FIG. 1, FIG. 2, FIG. 3, and FIG. 4 will be better understood in conjunction with the methodologies described hereinafter with respect to FIG. 5 and FIG. 6. Turning now to FIG. 5, there is shown a flowchart 500 illustrating a method for resource utilization-based throttling of software updates in accordance with one embodiment of the subject application. Beginning at step 502, a transfer of updated software is first commenced to the document processing device 104 so as to perform an update of operational software associated with the document processing device 104. For example, a software update transfer is begun between the server 114 and the document processing device 104 via the computer network 102. Resource utilization associated with the operation of the document processing device 104 is then sensed at step 504. An update process associated with the document processing device and the updated software is then throttled at step 506 in accordance with an output of the sensed resource utilization.

Referring now to FIG. 6, there is shown a flowchart 600 illustrating a method for resource utilization-based throttling of software updates in accordance with one embodiment of the subject application. The methodology depicted in FIG. 6 begins at step 602, whereupon the server 114 or other administrative device coupled to the computer network 102 receives software updates associated with the operational software of the associated document processing device 104. The operational software includes, for example and without limitation, executable code adapted to be executed by a processor associated with the document processing device 104 during processing of electronic documents communicated thereto, executable code corresponding to operational parameters associated with the document processing device 104, an associated installation utility adapted for updating operational software, or the like. In addition, the skilled artisan will appreciate that other examples include, without limitation, configuration updates, feature updates or additions, network settings, user administration settings, or other types of software facilitating or controlling operations of the associated document processing device 104. In accordance with one embodiment of the subject application, the update software received by the server 114 is stored in the data storage device 116.

At step 604, the server 114 generates an update list inclusive of all software updates relevant to the associated document processing device 104. According to one embodiment of the subject application, the list includes all software updates associated with the document processing device 104 stored in the data storage device 116. Preferably, this update list is made available to the associated document processing device 104 upon receipt of a request for the list from the device 104. Upon a determination that an update list request has been received at step 606, the server 114 communicates the list of update software to the requesting document processing device 104 via the computer network 102 at step 608. The controller 108 or other suitable component associated with the document processing device 104 then processes the update list at step 610. A determination is then made by the controller 108 whether any updates are available as set forth by the update list at step 612. For example, when all updates on the list have previously been incorporated by the controller 108, no new updates have been added, or the like, the controller 108 terminates the update process.

Upon a determination that an update is available, flow proceeds to step 614, whereupon a determination is made whether the update is time restricted. That is, a determination is made by the controller 108 whether or not the available update is restricted to transfer and installation at a specific time, e.g., after a predetermined period of inactivity of the document processing device 104, late evening, early morning, or other time when network or device resources are most likely available. When the available software update is determined to be a time restricted update, flow proceeds to steps 616, whereupon the controller 108 checks for the appropriate time. In the event that the time has not arrived for continuing the update process, flow proceeds to step 618, whereupon the controller 108 waits until the appropriate time for continuing the process.

When the appropriate time has arrived, as determined at step 616, or when the software update is not time restricted at step 614, flow proceeds to step 620, whereupon resource utilization associated with the document processing device 104 is sensed. In accordance with one embodiment of the subject application, such sensing includes, for example and without limitation, determining bandwidth utilization associated with a data path with the document processing device 104, determining processor utilization of a processor associated with the document processing device 104, determining memory utilization associated with the document processing device 104, and the like. In accordance with one embodiment of the subject application, such sensing includes, for example and without limitation, determining whether bandwidth utilization associated with a data path with the document processing device 104, or processor utilization of a processor associated with the document processing device 104, or memory utilization associated with the document processing device 104, and the like, are in accordance with a given mathematical function. Other examples will be apparent to those skilled in the art regarding resource utilization associated with the document processing device 104 and are capable of inclusion herein.

A determination is then made at step 622 based upon the sensed resource utilization, whether resources are available to continue the update process. When resources are not available, e.g., network congestion, large pending document processing jobs, errors experienced by the document processing device 104, or the like, the operation terminates. When resources are available, flow proceeds to step 624, whereupon the controller 108 or other suitable component associated with the document processing device 104 determines if the update corresponds to a previously interrupted or suspended software update. When a previously suspended update is detected, flow proceeds to step 626, whereupon the controller 108 retrieves, from the data storage device 110, suspension data corresponding to the suspended software update, e.g., software downloaded, where in the update process the operation was suspended, and the like. Thereafter, the transfer of the incomplete software update is re-initiated at step 628. Flow then proceeds to step 632, discussed in greater detail below.

Returning to step 624, when a determination is made that the software update does not correspond to a previously suspended update, flow proceeds to step 630, whereupon a transfer of the software update from the server 114 to the document processing device 104 is initiated. Flow then proceeds to step 632, whereupon a determination is made whether the transfer is complete. When the transfer is not complete, a determination is made at step 636 whether or not resources remain available to continue the update process. When resources remain available, the process continues until the transfer is complete, i.e., flow returns to step 632. When resources are no longer available, flow progresses to step 638, whereupon the transfer of the software update is suspended. Suspension data corresponding to the progress made during the transfer of the software update is then stored at step 640 in the associated data storage device 110 for later completion. Operations then return to step 610 and functioning of the methodology of FIG. 6 continues in accordance with the description set forth above.

Upon a determination at step 632 that the transfer of the software update is complete, flow proceeds to step 634 for a determination of whether another software update is available. When another software update is available, flow returns to step 610, whereupon the update list is processed to determine which of the available software updates in the list is next to be transferred from the server 114 to the document processing device 104. Operations thereafter proceed as set forth above. When no further software updates are available, operations with respect to FIG. 6 terminate. Thereafter, as will be appreciated by those skilled in the art, the operational software of the document processing device 104 is updated in accordance with the received software updates.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for resource utilization-based throttling of software updates comprising:
software transfer means adapted for commencing a transfer of updated software to a document processing device so as to perform an update of operational software associated therewith;
sensing means adapted for sensing resource utilization associated with operation of the document processing device; and
control means adapted for throttling an update process associated with the document processing device and the updated software in accordance with an output of the sensing means.

2. The system of claim 1 wherein resource utilization includes at least one utilization parameter from the set comprising bandwidth utilization associated with a data path with the document processing device, processor utilization of a processor associated with the document processing device, and memory utilization associated with the document processing device.

3. The system of claim 1 wherein the control means includes means adapted for periodically altering the update process in accordance with temporally displaced output from the sensing means.

4. The system of claim 1 wherein the control means further includes means adapted for throttling the update process in accordance with a mathematical function related to an output of the sensing means.

5. The system of 1 wherein the control means includes means adapted for suspending the update process in accordance with an output of the sensing means.

6. The system of claim 1 wherein the update process includes at least one process chosen from the set comprising communicating the operational software to the document processing device and installing the operational software on the document processing device.

7. The system of claim 1 wherein the operational software includes executable code adapted to be executed by a processor associated with the document processing device during processing of electronic documents communicated thereto.

8. The system of claim 1 wherein the operational software includes non-executable s code corresponding to operational parameters associated with the document processing device.

9. The system of claim 1 wherein the operational software includes an associated installation utility adapted for updating the operational software.

10. The system of claim 1 further comprising means adapted for enabling the software transfer means at a selected time.

11. A method for resource utilization-based throttling of software updates comprising the steps of:
commencing a transfer of updated software to a document processing device so as to perform an update of operational software associated therewith;
sensing resource utilization associated with operation of the document processing device; and
throttling an update process associated with the document processing device and the updated software in accordance with an output of the sensing of resource utilization.

12. The method of claim 11 wherein resource utilization includes at least one utilization parameter from the set comprising bandwidth utilization associated with a data path with the document processing device, processor utilization of a processor associated with the document processing device, and memory utilization associated with the document processing device.

13. The method of claim 11 wherein the step of throttling an update process includes periodically altering the update process in accordance with temporally displaced output from the sensed resource utilization.

14. The method of claim 11 wherein the step of throttling an update process includes throttling the update process in accordance with a mathematical function related to an output of the sensed resource utilization.

15. The method of 11 wherein the step of throttling an update process includes suspending the update process in accordance with an output of the sensed resource utilization.

16. The method of claim 11 wherein the update process includes at least one process chosen from the set comprising communicating the operational software to the document processing device and installing the operational software on the document processing device.

17. The method of claim 11 wherein the operational software includes executable code adapted to be executed by a processor associated with the document processing device during processing of electronic documents communicated thereto.

18. The method of claim 11 wherein the operational software includes non-executable code corresponding to operational parameters associated with the document processing device.

19. The method of claim 11 wherein the operational software includes an associated installation utility adapted for updating the operational software.

20. The method of claim 11 further comprising the step of enabling the transfer of the software at a selected time.
